(19) United States
(12) Patent Application Publication
(10) Pub. No.: US 2026/0329258 A1
(43) Pub. Date: Oct. 22, 2026

(54) METHOD FOR COMPUTER-SUPPORTED INSTALLATION OF SPATIALLY DECENTRALISED ELECTRICAL COMPONENTS OF A MACHINE

(71) Applicant: Murrelektronik GmbH, Oppenweiler (DE)

(72) Inventors: Sebastian Pfestorf, Oppenweiler (DE); Paul Zeller, Flein (DE); Ulrich Viethen, Tiefenbach (DE)

(21) Appl. No.: 19/109,610

(22) PCT Filed: Sep. 20, 2023
(86) PCT No.: PCT/EP2023/075916

§ 371 Date: Mar. 7, 2025

(30) Foreign Application Priority Data
Sep. 30, 2022 (EP) 22199162.3

(51) Int. Cl. G05B 19/418

(52) U.S. Cl. CPC G05B 19/41805; G05B 2219/31027; G05B 2219/31034

(57) ABSTRACT

The invention relates to a method (100) for a computer-aided installation of spatially decentralized electrical components (4) of a machine (1), in particular a plant (1), comprising: Receiving (101) an identifier (11) of an installation element (10), preferably a cable or a component; Providing (102) an installation specification (200) which specifies an assignment of the installation element (10) for connection to an electrical component (4), preferably in the form of a connection module (4) for connection to the installation element (10) and further installation elements (10); Identifying (103) the electrical component (4) based on the provided installation specification (200); and Initiating (104) an output of at least one installation information based on the received identifier (11) and the identified component (4).

### TECHNICAL AREA

The present invention relates generally to the field of planning and assembly of machines such as automation systems, and in particular to a computer-aided installation of spatially decentralized electrical components of a machine.

### BACKGROUND

The complexity and variety of automation systems that need to be developed, planned, installed, maintained and repaired is constantly increasing. In all phases of the life cycle of such a system, such as development/planning, production, commissioning, operation and maintenance, efficient and effective support for an installer or planner through comprehensive and, above all, complete documentation is becoming increasingly important. However, the documentation available in practice, for example in the form of circuit diagrams, does not always meet this requirement, as poorly coordinated work processes or the use of poorly coordinated documentation tools mean that installation activities are not recorded sufficiently or completely. These known circumstances inevitably lead to documentation gaps in the system documentation, which makes reliable maintenance or repair of a system more difficult or, in the worst case, impossible.

It is therefore a task underlying the invention to provide a computer-aided method and a system to enable a simpler, faster, safer and error-free installation of electrical components, thereby at least partially overcoming the above-mentioned disadvantages of the prior art.

### Disclosure of the Invention

The above problem is solved by a method, system, computer program and an apparatus for data processing according to the independent patent claims. Further features and details of the invention may be seen from the respective sub-claims, the description and the drawings.

The object of the invention is in particular a method for a computer-aided, in particular electrical, installation of spatially decentralized and/or electrical components of a machine, in particular a plant, preferably an electrotechnical plant.

The machine may be designed as at lease one of the following machines:
An automation system,
A production plant,
A logistics facility,
A production line,
A machining center,
An industrial robot,
A production plant,
An aggregate,
An electrical appliance.

In particular, the machine may be designed as a machine with a modular character or also as a mobile or movable machine, in which individual parts of the machine are installed modularly in accordance with an installation specification. This installation is at least partially carried out manually by a user such as a worker.

The electrical components may be connection modules that enable a decentralized and modular connection of installation elements. Decentralized may refer to the fact that the connection modules at least partially replace a central control cabinet in that the connection modules only provide some of the connections for the machine, but enable these connections to be made decentrally in the field. In the case of a central topology, e.g. a centralized control cabinet concept, in particular about a point-to-point connection is provided, i.e. the starting point, the connection and the end point are clearly defined. In contrast, in decentralized applications it is possible, or may even often be necessary, to arrange or connect several components between the starting point and the end point. This may be referred to as a module-module or module-hub-point connection, for example. In principle, the following components may be provided in a machine, for example: Devices such as actuators and/or sensors, the connection modules, installation elements, e.g. for cabling.

The method according to the invention may comprise the following steps, which are preferably carried out one after the other or in any order, wherein the steps may also be carried out automatically and/or repeatedly:
Receiving an identifier, in particular a digital identifier, of an installation element, preferably a cable or a component, the identifier preferably being received by a detection device which has previously read in a physically present identification means such as a machine-readable code and has generated the identifier based on the read-in identification means,
Providing an installation specification, in particular a digital installation specification, which specifies an assignment of the installation element for connection to an electrical component, preferably in the form of a connection module for connection to the installation element and other installation elements,
Identifying the electrical component based on the provided installation specification, preferably by querying the electrical component from the installation specification using the identifier, preferably from a list and/or database of the installation specification,
Initiating an output of at least one installation information based on the received identifier and the identified component, wherein preferably the output comprises a visual and/or acoustic output to a user.

The method thus enables a simpler, faster and error-free assignment of installation elements to components and may thus significantly support a user for the installation of the machine and simplify the process. Furthermore, in this way a support system for installation, in particular for wiring, may be provided spatially directly at the identified component for guided orientation of the user, in which a data processing apparatus may automatically execute the method steps. The data processing apparatus, in particular a data processing apparatus according to the invention, may advantageously communicate with individual components and thus enable the output of the installation information. For this purpose, the data processing apparatus may have at least one interface for communication.

A user may be, for example, an installer and/or plant mechanic and/or electrician and/or worker and/or planner and/or mechanical designer or developer and/or electrical designer or developer and/or PLC programmer and/or commissioning engineer and/or maintenance engineer and/or machine operator. It is possible for the user to use the method according to the invention by providing the method to the user via a computer. For this purpose, a computer program may be executed at least partially by the computer and/or another computer in order to carry out the method steps according to the invention

Furthermore, it is possible for several users to use the method according to the invention simultaneously or at least partially simultaneously. Accordingly, the steps of a method according to the invention may also be carried out several times and/or at least partially in parallel. For example, the steps are carried out at least partially simultaneously for at least two or at least three or at least four users.

Several installation elements may be provided for the installation of the machine. These installation elements may each be assigned an identifier by which the installation elements may be uniquely identified. The identifier may accordingly be information that may be processed digitally, for example. The respective installation element may comprise the identifier in that a physical identification means is provided and/or attached to the installation element. The installation elements may, for example, be cables or components that are a functional part of the machine. The identifier advantageously comprises a unique and, in particular, unambiguous labeling. This makes it possible to uniquely identify the installation element using the identifier in connection with the machine and/or other machines and/or the installation of the machine. One or more pieces of information about the installation element may be assigned to the identifier. The at least one piece of information may include at least one of the following: at least one status information, the installation information issued, an identifier of the identified component, at least one of the documentation specifications described in more detail below, such as component type, machine type, system type, user, connection point designation, time stamp date and time, installation duration, address in a bus system, equipment identification, cable length, port assignment, properties of the open cable, temperature, humidity, current project status during installation, deviation from plan and reason. Digital storage of the at least one information associated with the identifier thus makes it possible to create a digital twin of the installation element. In this way, passive smartification of the installation element may be made possible.

Smartification refers in particular to the addition of intelligent properties to an industrial product such as a component and/or a part and/or an installation element, e.g. a cable. Information technologies may be used to enable components to process data and offer additional added value. Passive smartification may be provided as a corresponding preliminary stage by means of a passive intelligent component such as an NFC chip (near field communication, abbreviated NFC) and/or a machine-readable code. In this way, a basis may be created for automated recording or for changes and their effects on the function of a machine. The unique, preferably unambiguous labeling in conjunction with access to an external database may enable the active enrichment of information and thus passive smartification.

In particular, devices of the machine such as actuators and/or sensors are operated, i.e. preferably controlled and/or read out, via the installation elements. A control device such as a PLC (programmable logic controller) may be provided for the operation of the devices, which may carry out the electrical operation of the devices via the installation elements and components. For this purpose, the control device may be electrically connected to the components.

Preferably, the installation element may comprise a cable and/or a component, wherein the cable may have at least or exactly one plug connector, and may preferably be assembled on one side, i.e. has a female or male plug on one side and an open end on the other side. Alternatively, the cable may also be assembled on two sides, i.e. the cable has a female or male connector on each side.

It may also be possible that the at least one installation information comprises an installation instruction to assist a user such as a worker and/or installer with the installation. The installation instruction may also comprise instructions for the installation, e.g. step-by-step instructions.

Initiating the output may comprise at least one of the following steps:
Initiating an activation of a display element such as a light-emitting diode on the electrical component in order to indicate a connection point, in particular a slot, for the installation element to be connected by means of the display element, wherein the display element may preferably light up as a result of the activation,
Initiating an indication of a connection point, in particular a slot, of the electrical component for the installation element on a user interface of a computer, wherein preferably the user interface visualizes a digital twin of at least a part of the machine, and preferably visualizes a mechanical and/or an electrical structure of the part of the machine,
Initiating an indication of a connection point, in particular a slot, of the electrical component for the installation element using augmented reality,
Initiating an output of the installation instruction as an instruction for the user to connect the installation element to a specific connection point of the electrical component, the connection point preferably being determined based on the installation instruction,
Initiating an acoustic output, in particular a voice output, of the installation instruction.

This enables the user to be informed directly by the installation instruction as to how the installation element should be installed. For example, the connection point on the component to which the installation element is to be connected may be indicated by the display element lighting up. Furthermore, the lighting up of the display element may make it possible to indicate a correctly or incorrectly assigned connection point accordingly. For this purpose, the component may have several of the display elements, which are assigned to corresponding connection points of the component, e.g. through an adjacent arrangement on a connecting element. It is conceivable that a display element is assigned to each of the connection points on the component, which is attached to the component, for example, adjacent to the corresponding connection point.

The connection point, in particular a connection port, which is provided for the connection of the installation element with the received identifier in accordance with the installation specification, may be queried from the installation specification using the received identifier, for example. For this purpose, the installation specification may enable an electronic query, e.g. by means of a database and/or a list and/or the like. In the context of the present invention, an installation specification may be provided as an overview plan of an installation of decentrally arranged components on a system, for example in digital form. Based on the installation specification, one or more corresponding installation instructions may be derived from it before, during or after assembly, dismantling or reconstruction. The installation specification may be stored in a non-volatile data memory so that it may be accessed to carry out the computer-aided installation and the installation instruction may be made available. Access may also be possible via a network.

The indication of the connection point on the user interface may include, for example, a graphical representation of the connection points of the component, wherein the connection point that is intended for the connection of the installation element with the received identifier is graphically highlighted.

The user interface may be a graphical user interface that is displayed on a screen, preferably on a computer. The computer may, for example, be a portable computer such as a laptop or tablet.

The indication by means of augmented reality may be achieved, for example, by using VR (virtual reality) glasses by a user to indicate additional information and/or by recording the user's surroundings by a camera and processing the camera image to include additional information in the camera image. The additional information includes, for example, highlighting the connection point when the physical connection point of the component is visible in the camera image.

Furthermore, an acoustic output may also be provided, which includes, for example, the activation of a loudspeaker. The acoustic output may, for example, be a voice output that speaks the connection designation of the connection point.

It may be advantageous if, within the scope of the invention, the method comprises the following further step: Determining a connection status between the installation element and the electrical component in order to determine whether the connection has been established. For this purpose, for example, an electrical connection test may be carried out, by means of which it may be automatically determined whether the installation element and the electrical component have an electrically conductive connection. Depending on the design, it is conceivable that an electrical circuit is not yet immediately closed during the connection, especially if the installation has not yet been completed. Therefore additional or alternative options for determining the connection status may also be provided.

Thus, determining the connection status may further comprise: Receiving an installation message based on an input from the user and/or from the electrical component. The received installation message may indicate that the connection of the installation element to the electrical component, preferably to an indicated connection point of the electrical component, has been established. Accordingly, it may be checked that the connection point that was an indicated has actually been connected to the installation element. It is possible that a documentation is triggered by establishing the connection, e.g. by a manual acknowledgement by a user and/or an automatic acknowledgement by establishing the connection if, for example, both sides of a cable have been connected. The documentation includes, for example, installation documentation, as described in more detail below. This documentation may be executed repeatedly, e.g. each time an activity is acknowledged, in order to gradually build up the installation documentation. In order to make the installation instructions visible to the user in the machine and to be able to document the work carried out on the component in the system, it is advantageous that the system and preferably the device according to the invention may communicate with the components. Following the installation and/or the documentation, the control device may optionally be programmed and/or the component(s) configured based on the documentation. Due to this circumstance, it may be possible that the component does not know beforehand which task it has to perform in the future machine. This may also be referred to as “unconfigured”.

A further advantage within the scope of the invention may be achieved if the method comprises the following further steps:
Verifying the connection, preferably the connected connection point, using the installation specification, preferably a predetermined digital circuit diagram and in particular an electrical connection diagram, in particular in order to determine whether a user has correctly implemented the installation information in the form of an installation instruction, wherein preferably an identification for the installation specification is stored as a function of the verification, and particularly preferably the subsequent step is carried out in the event of a positive verification:
Storing the labeling of the connection point as a correctly connected connection point in the installation specification.

Advantageously, the verification may be carried out based on determining the connection status. The verification therefore makes it possible to assess whether the user has followed the installation instruction correctly. The result of the verification may be used to store the labeling in the installation specification. This means that the installation specification may be used at a later time to check whether the installation specification was followed and/or to what extent the installation specification was deviated from during installation.

If a user deviates from the installation instruction, this is often for a relevant reason or occasion. Therefore, a user may be provided with the option of entering an installation parameter, for example via the user interface and/or an input device such as a voice input and/or a keyboard and/or a mouse and/or a touch screen. Advantageously, in the event of a negative verification, i.e. if the user has not correctly implemented the installation instruction, at least one of the following steps may be carried out: Storing an identification of the connection point as a changed connected connection point in the installation specification, preferably based on an installation parameter recorded by the user, in particular an occasion or reason for the change, wherein preferably an indication of the occasion or reason for the change is also stored, and preferably: Initiating a correction of the connection in accordance with the installation specification. The correction may, for example, include an adjustment to the installation specification if the new connection is justified and therefore makes a beneficial contribution to the desired installation.

Optionally, it may further be provided that the method comprises the following further step, wherein the step is preferably performed during the verification of the connection:
Validating the, in particular verified, connection with regard to a complete establishment of the connection, in particular a proper screw connection and/or power and/or data connection and/or contacting, preferably by means of a measured variable transmitted by an external test means, in particular a sensor or a test tool, in order to determine whether a user has complied with a predetermined measured variable.

This makes it possible to ensure that, depending on the installation environment, the respective valid or necessary requirements for the materials used or the connection are guaranteed. Furthermore, this has the advantage that safety risks are significantly reduced during the installation of machines. The specified measured variable may be a reference value, which is compared with the transmitted measured variable as the current measured value. The establishment of the connection may, for example, be considered correct and/or complete if the transmitted measured variable fulfills a predefined condition such as exceeding the reference value.

Further, it may be provided that the at least one installation information comprises an installation instruction for assisting a user in a reconstruction of the machine, wherein preferably initiating the output comprises at least the following step: initiating an output of an installation sequence by means of the at least one installation information for the installation of the machine. The installation information may, for example, comprise an installation instruction which also indicate an order of installation. This simplifies the installation for a user and speeds up the installation, since a time-consuming interpretation of a circuit diagram and, in particular, a connection diagram is no longer necessary, at least in part.

According to an advantageous further development of the invention, it may be provided that the initiation of the output comprises an initiation of a bidirectional communication with the identified component via a bus system. The output may be triggered, for example, by transmitting a specific message, preferably a command, to the component via the communication. For this purpose, for example, a computer program may be executed by a data processing apparatus, wherein the data processing apparatus is connected to the bus system.

Advantageously, the invention may provide that at least one of the following specifications is received, preferably by the installation message, to create a digital twin of the installation element and/or the electrical component based on the received identifier and the identified component: Component type, machine type, plant type, user, connection point identifier, timestamp date and time, installation duration, address in a bus system, equipment identifier, cable length, port assignment, open cable characteristics, temperature, humidity, current project status at installation, deviation from plan and reason. The at least one specification may also be referred to as a documentation specification in the context of the present invention.

The installation message may, for example, have been generated based on an input from a user, wherein the user may have indicated the at least one specification in the input. It is also possible for the specification to be determined automatically, e.g. by the component and/or a data processing apparatus, in particular based on the identifier received. For this purpose, for example, the at least one specification may be stored in the component and/or in the installation element.

In a further possibility, it may be provided that the installation information comprises an installation configuration and/or installation documentation, preferably for a disassembly and/or reassembly of the machine, which is stored for documentation, preferably stored in a data memory and/or transmitted to the electrical component. The data memory may be designed as a non-volatile data memory in order to reliably enable a later evaluation of the installation configuration and/or the installation documentation. The installation configuration and/or the installation documentation may, for example, include the stored identification based on the verification.

A further advantage may be achieved in the context of the invention if the installation information comprises a unique labeling which labels the installation element and/or the identified component, wherein the installation information is stored in the installation specification, in particular in a digitized construction plan, preferably comprising ECAD and/or MCAD data, and/or wherein the installation element is selected from a plurality of similar installation elements and/or the identified component is selected from a plurality of similar components based on the identifier. The installation specification thus makes it possible to use the labeling and/or the identifier to query the assignment of the installation elements to the components. For this purpose, the installation specification may include a link between the labeling and/or with the identifiers. The identifier may optionally be uniquely assigned to one of the labelings of the installation elements and/or the identifier may correspond to this labeling.

A further advantage within the scope of the invention may be achieved if the installation specification comprises a predefined specification of a modular and/or decentralized structure of the machine, in particular of the system, preferably based on predefined ECAD and/or MCAD data, in particular via an interconnection of the installation elements in the form of cables and/or components by means of the component in the form of connection modules, preferably comprising an electrical connection diagram, the installation specification preferably being determined by linking the ECAD and MCAD data. The installation specification may thus comprise a digital circuit diagram and/or construction plan and/or installation plan of the machine.

It is also conceivable within the scope of the invention that the component is configured using the identifier in order to transfer the component from a basic configured state, in which the component is preferably configured for bidirectional communication by means of a bus system and/or a functional control by a control device, preferably a PLC, is excluded, to a state with an extended configuration for a functional control by the control device.

The identifier received makes it possible to recognize which installation element has been (or is to be) connected to the component. This recognition may be used to automatically carry out the configuration of the components required for the installation, which significantly reduces the configuration work on a component during installation. For example, the identifier received and the installation specification are used to determine which of the components is (or will be) connected to the installation element. Accordingly, the component may be configured for this installation element so that it is known to the control device that the installation element is connected to this component for subsequent functional activation by the control device. This enables the control device, for example, to operate at least one device of the machine, such as an actuator and/or sensor, via this component and/or the installation element. Another object of the invention is a system for a computer-aided installation of spatially decentralized electrical components of a machine, comprising a detection device, in particular a scanner such as a hand scanner or a camera, for providing an identifier of an installation element, preferably a cable or a component, further comprising at least one electrical component, preferably in the form of a connection module for connection to the installation element and further installation elements, and a device for data processing, comprising means for carrying out the steps of a method according to the invention. The system according to the invention thus has the same advantages as those described in detail with reference to a method according to the invention.

Optionally, the computer-aided installation may be carried out by supporting the installation by a system, in particular according to the invention, and/or at least one device for data processing, in particular according to the invention, such as at least one computer. For this purpose, the system and/or the at least one device may be suitable for at least partially executing the method steps of a method according to the invention.

Furthermore, “computer-aided” may preferably refer to the fact that the installation in the form of a real installation, in particular of the components in the form of real electrotechnical components, is supported by a (in particular the aforementioned) system and/or by at least one (in particular the aforementioned) device such as at least one computer, in that the method steps of a method according to the invention are preferably at least partially carried out in preparation for and/or accompanying the (real) installation. The installation information and/or an installation instruction may then, for example, be made available to an installer for the further implementation of the installation, for example by means of an output, in particular by means of a screen and/or a voice output and/or by means of augmented reality.

In addition, a device for data processing, comprising means for carrying out the steps of a method according to the invention, may also be an object of the invention. The device may be adapted to communicate with the components, in particular modules, of the machine, in particular plant, preferably without the modules being preconfigured and/or connected to a control device.

Furthermore, it may be provided that the identifier is encoded in a machine-readable code assigned to the installation element, in particular arranged on the latter, the machine-readable code being machine-readable by means of the detection device.

In addition, it is possible that the components and a computer and/or a control device are each connected to one another via a bus system for bidirectional communication, wherein bidirectional communication is provided based on a communication protocol for a field bus system, in particular based on a ProfiNet, Ethernet/IP, EtherCAT or 802.3 standard, and/or bidirectional communication is provided in a wired manner via a bus system or wirelessly by means of Bluetooth or WLAN, based on a standard in accordance with IEEE 802.11 or based on a mobile telecommunication standard.

Another object of the invention is a computer program comprising instructions which, when the program is executed by a computer, such as the data processing apparatus according to the invention, cause the computer to carry out the steps of a method according to the invention. The computer program according to the invention thus has the same advantages as those described in detail with reference to a method according to the invention.

It is possible for several users to carry out the (same) method steps simultaneously and/or at least partially simultaneously. The simultaneous and/or at least partially simultaneous execution of (the same) method steps by several users is also referred to below as a multi-user application.

A further method for a computer-aided installation of spatially decentralized electrical components of a machine may also be an object of the invention, in which the installation is carried out simultaneously and/or at least partially simultaneously by at least two users.

In connection with a method according to the invention, in particular in a multi-user application and/or in the further method, a handover between the different users may be provided. In order to enable a handover between the, preferably both, users and to ensure an optimal process, a processing status of the respective user may be automatically and digitally documented in real time. This allows the two or more users to work simultaneously on different areas of the machine without jeopardizing the integrity of the electrical installation or having to carry out lengthy coordination processes.

It may be advantageous if the current status of the installation is indicated in real time. Furthermore, an installation instruction may be assigned to the respective user and digitally documented. In this way, relevant information may be collected during the installation process. The information collected includes, for example:
A user-specific identifier and role (access and editing authorizations, qualification level if applicable), and/or
A last used connecting element and/or a last used component and/or a last used part, and/or
A last processed location, in particular a segment, of the machine to which the last used connection module and/or part and/or component was attached, and/or
A last user (unique user ID) and the time of the user's last edit, and/or;
A last identified connecting element, preferably a scanned component, and a machine area for which the connecting element or component is intended.

It may be provided that at least two users carry out the installation of spatially decentralized electrical components of a machine. Each user may log in via the user interface of a computer, preferably a portable computer, and then, for example, select a work order to be processed in order to start the installation. Selecting a work order or an installation instruction locks it for the other users. Each user may log in and make selections on their own computer. The computers are connected to each other via a network and/or to a server, for example, in order to synchronize the selection with each other.

To identify an installation element suitable for installation, in particular a component or cable, each user may use a detection device, in particular a scanner or camera, as a reader. This allows the respective user to link the reader used in each case with the user's current order electronically and using data technology in order to document the individual installation progress.

A unique labeling may be provided for each user in order to identify the user based on the labeling. The labeling may, for example, be linked to a user name, which is specified when the user logs in. With the login of each of the at least two users using the user-related labeling, the computer program may access the user-related data and issue the installation instruction to the user according to the user's capabilities. In this way, only new data may be recorded or collected for first-time users of the system in order to create an appropriate profile for repeated use or installations to be carried out. By documenting the time required per installation step, standard values may be determined in order to categorize users into “fast/slow/average” according to their skills during installation. This allows authorizations or roles to be adapted in advance for each user on a user-specific basis. Furthermore, the level of detail of the instructions may be adjusted using the stored data on the training level of the user. By documenting user-related work steps, the computer program may access the last installation step performed and indicate it to the user.

After logging in, the installation may be started on the machine or continued on the last component processed by the user, in particular a segment of the machine.

By identifying an installation element of a component suitable for installation, in particular components and cables, using the data processing apparatus, a new work step may be initiated if necessary. Using a topology stored in the installation specification and the electrical structure based on the ECAD data, the initiated work step may advantageously be clearly assigned to an area in the machine and within the installation plan.

Once the work step has been completed, the individual assembly progress may be documented by means of manual and user-specific confirmation of correct assembly.

Once the correct installation has been confirmed, this step is saved in the system with the user ID so that the last status may be viewed and continued in the event of a user change.

A further method for a computer-aided installation, in particular electrical installation, of spatially decentralized and/or electrical components of a machine, in particular a system or plant, may also be an object of the invention.

Advantages and features described in connection with the method according to the invention also apply in connection with the further methods according to the invention, and vice versa in each case.

The further method according to the invention may comprise the following steps, which are preferably carried out one after the other or in any order, wherein the steps may also be carried out automatically and/or repeatedly and/or at least partially in parallel in terms of time:
Providing at least or exactly two user-specific installation specifications, which specify an assignment of at least one installation element, preferably a cable or a component, and at least one electrical component, preferably in the form of a connection module for connection to the installation element and other installation elements, for the installation and its functionality,
Providing at least or exactly two system/plant specifications which are specific to segments, e.g. parts or locations, of the machine, preferably the automation system/plant,
Optional: Providing at least or exactly one installation reference,
Generating at least or exactly two user-specific installation instruction for the simultaneous support of at least two users, in particular workers or planners, for the installation of the same machine, in particular plant, based on the installation specification provided and/or an installation reference and/or user-specific criteria and/or the system specification.

In other words, installation instructions may be issued for multiple users so that the users may perform the installation at least partially simultaneously. It is possible that the installation instruction is not only dependent on the segment of the machine that is installed by the respective user, but also on further user-specific criteria. At least one or more installation reference(s) and/or user-specific criteria may be provided for this purpose.

In a further possibility, it may be provided that the generation of at least one of the user-specific installation instructions comprises the following steps in each case:
Receiving an identifier of one of the users, preferably an unambiguous labeling,
Analyzing multiple provided installation references for their suitability to the user's specific criteria based on a predetermined suitability rule, in particular installation history, installation efficiency and user access permissions, and
Selecting an installation instruction suitable for the user from the analyzed installation references based on the analysis,
Providing the at least one installation instruction based on the analysis.

A further advantage within the scope of the invention may be achieved if the generation of the at least one installation instruction comprises the following steps:
Selecting at least one of the segments, in particular at least one system component, of the machine or automation system based on the system specification,
Comparing the at least one selected segment with at least one reference segment, in particular at least one reference component, of the installation reference provided based on a predefined installation instruction, in particular a guideline, and
Providing at least one installation instruction based on the comparison.

It is also conceivable within the scope of the invention that the comparison of the at least one selected segment comprises the following steps:
Analyzing several reference segments of the provided installation reference with regard to suitability for the selected segment;
Selecting a suitable reference segment for the selected segment from the analyzed reference segments based on the analysis, and
Comparing the selected segment with the selected reference segment using the specified installation instruction.

In addition, it may be provided that providing the at least one installation instruction comprises the following steps:
Identifying an installation instruction based on the comparison,
Analyzing the respective identified installation instruction with regard to a suitability as an installation instruction for the selected segment,
Selecting at least one suitable installation instruction from the analyzed installation instructions based on the analysis.

A further advantage within the scope of the invention may be achieved if the further method comprises the following further steps:
Receiving an identifier of an installation element, preferably a cable or a component,
Analyzing whether the received identifier has already been received,
   wherein the following step is preferably carried out in the event of a positive analysis result:
Blocking the provisioning process of a user-specific installation specification,
   wherein the following steps are advantageously carried out in the event of a negative analysis result:
Providing a user-specific installation specification, which specifies an assignment of the installation element for connection to an electrical component, preferably in the form of a connection module for connection to the installation element and other installation elements,
Identifying the electrical component based on the provided installation specification; and
Initiating an output of at least one installation information based on the received identifier, the identified component and the user information.

In a further possibility, it may be provided that the at least one installation information comprises at least two installation instructions for assisting at least two users with the installation, wherein preferably initiating the output comprises at least one of the following steps:
Initiating an activation of a display element on the electrical component, to indicate a connection point, in particular a slot, for the installation element to be connected by the display element;
Initiating an indication of a connection point, in particular a slot, of the electrical component for the installation element on a user interface of a computer, wherein the user interface visualizes a digital model of at least a part of the plant, and preferably visualizes a mechanical structure of the part of the plant;
Initiating an indication of a connection point, in particular a slot, of the electrical component for the installation element using augmented reality,
Initiating an output of a user-specific installation instruction as an instruction for an individual user to connect the installation element to a specific connection point of the electrical component, the connection point preferably being determined based on the user-specific installation specification,
Initiating an acoustic output, in particular a voice output, of the installation instruction.

It is also conceivable within the scope of the invention that the further method comprises the following further steps:
Verifying the connection, preferably the connected connection point, based on the installation specification, preferably a predetermined digital electrical connection diagram, in particular in order to determine whether a user has correctly implemented the installation information in the form of an installation instruction, an identification for the installation specification preferably being stored as a function of the verification, and
   at least one of the following steps is preferably carried out in the event of a positive verification:
Storing a user identification to assign the connected connection point to the respective user,
Storing a timestamp to extend the user data and the installation reference,
Storing the labeling of the connection point as a correctly connected connection point in the electrical connection diagram,
   wherein at least one of the following steps is advantageously carried out in the event of a negative verification:
Storing a labeling of the connection point as a changed connected connection point in the electrical connection diagram,
Storing the user identification to assign the changed connected connection point to the respective user,
Storing a timestamp to extend the user data and the installation reference,
Initiating a correction of the connection according to the electrical connection diagram.

In a further possibility, the installation specification may include a specification of a topological arrangement of the electrical components in which the electrical components are interconnected.

A further advantage within the scope of the invention is achievable if at least one of the following specifications is received, preferably by the installation message, in order to create digital twin of the installation element and/or the electrical component based on the received identifier and the identified electrical component: Component type, machine type, plant type, user, connection point designation, timestamp date and time, installation duration, address in a bus system, equipment identification, cable length, port assignment, open cable properties, temperature, humidity, current project status during installation, deviation from plan and reason.

A further advantage may be achieved within the scope of the invention if the provided installation reference comprises, at least in part, one or more of the following reference data:
initial reference data relating to a mechanical arrangement of a reference system, in particular MCAD data,
second reference data relating to an electrical cabling of a reference system, in particular ECAD data,
third reference data, comprising one or more images, preferably scans, of an installed automation system or system components,
fourth reference data, including system environment data,
fifth reference data, comprising historical user data, in particular qualification status, access authorizations, user ID and historical work speed.

A further advantage may be achieved if the method comprises at least one of the following further steps:
Initiating a saving of the generated at least two installation instructions as an executed installation,
Initiating a storage of the generated at least two installation instructions as another part of the provided installation reference.

A (further) system for a computer-aided installation, in particular electrical installation, of spatially decentralized and/or electrical components of a machine, in particular a plant, may also be an object of the invention, comprising:
a reading device for an identifier of an installation element, preferably a cable or a component,
the electrical component, preferably in the form of a connection module for connection to the installation element and other installation elements;
a data processing apparatus comprising means for carrying out the steps of the method.

In a further possibility, it may be provided that the identifier is encoded in a machine-readable code assigned to the installation element, in particular arranged thereon, wherein the machine-readable code is machine-readable by means of a reading device assigned to an installer by means of a unique identifier; and/or wherein the components and a computer and/or a control device are each connected to one another via a bus system for bidirectional communication, wherein the bidirectional communication is provided based on a communication protocol based on a ProfiNet, Ethernet or 802.3 standard and/or the bidirectional communication is wired via a bus system or wireless via Bluetooth, or WLAN, based on a standard according to IEEE 802.11 or based on a mobile telecommunication standard.

### BRIEF DESCRIPTION OF THE DRAWINGS

For a better understanding of the disclosure, it is referred to the following drawings:

FIG. 1: A central connection in a machine by means of a control cabinet.

FIG. 2: A decentralized circuit according to embodiments of the invention.

FIG. 3 A schematic representation of parts of a system according to embodiments of the invention.

FIG. 4 A schematic representation of details of a method according to embodiments of the invention.

FIG. 5 A schematic representation of steps of a method according to embodiments of the invention.

### DESCRIPTION OF THE EMBODIMENTS

Planning, installing and setting up machines and electronic automation technology is a complex task. This applies to centralized control cabinet systems as well as decentralized systems in which control modules are attached directly to the systems. The corresponding processes are carried out by different people, such as system planners, electrical planners, installers, system programmers, etc. A special feature of decentralized systems is the distribution of modules at different points on a machine compared to centralized control cabinet systems. For larger machines in particular, simultaneous installation, i.e. installation carried out by several users at the same time, may be advantageous for time and logistical reasons. To enable a smooth installation process, the work status should be documented automatically, user-specifically and digitally in real time. For various reasons (e.g. maintenance planning, system diagnostics), it is important to have complete documentation of all relevant information throughout the entire system life cycle.

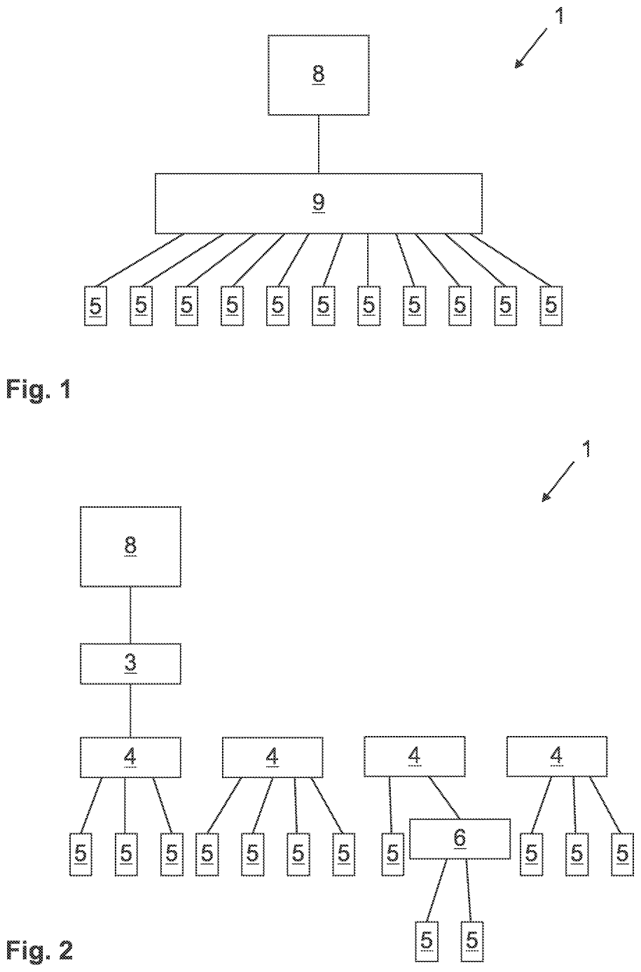

FIG. 1 schematically shows a centralized connection using a control cabinet 9 in order to contrast this with a decentralized connection using spatially decentralized electrical components 4 of a machine 1 in FIG. 2. Instead of connecting all devices 5 such as sensors and actuators directly to the control cabinet 9 as shown in FIG. 1, several components 4, in particular connection modules, may be used in the decentralized wiring in FIG. 2. Like the control cabinet 9, these enable the devices 5 to be coupled with a control device 8 such as a PLC. However, the connection modules 4 may be decentralized and distributed in the vicinity of the devices 5. The connection modules 4 thus only partially interconnect the devices 5, wherein the connection modules 4 together or, for example, one and/or more connection modules 4 carry out the entire interconnection via one and/or more hubs 6. In order to enable the configuration and/or control of the connection modules 4 centrally, a master module 3 may be connected upstream of several of the individual connection modules 4. It is also possible for the interconnection to be further subdivided by means of at least one hub 6.

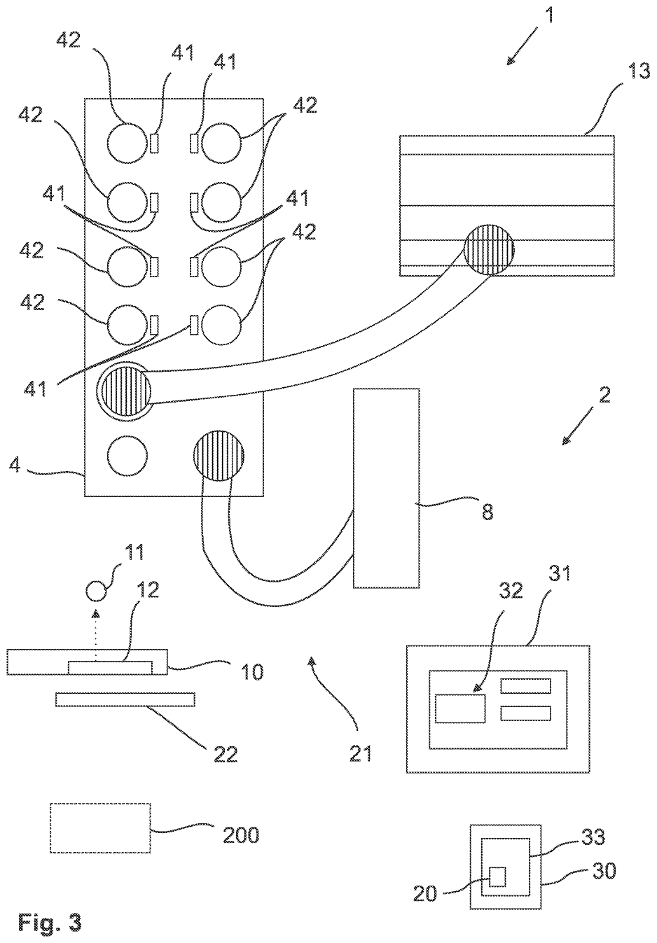

FIG. 3 shows parts of a system 2 according to embodiments of the invention, which may be provided for a computer-aided installation of spatially decentralized electrical components 4 of a machine 1. The system 2 may comprise a detection device 22, in particular a scanner 22 or a camera 22, for providing an identifier 11 of an installation element 10, preferably a cable 11 or a component 11. Furthermore, the system 2 may comprise at least one electrical component 4, preferably in the form of a connection module 4 for connection to the installation element 10 and other installation elements 10. Likewise, a data processing apparatus 30 may be part of the system 2, wherein said data processing apparatus 30 may comprise means for performing the steps of a method 100 according to embodiments of the invention.

The identifier 11 may be encoded in a machine-readable code 12 associated with the installation element 10, in particular arranged thereon, wherein the machine-readable code 12 is designed to be machine-readable by means of the detection device 22. This makes it possible for a user to scan the code 12 by means of the detection device 22 and thus transmit the identifier 11 to the data processing apparatus 30.

Furthermore, the components 4 and at least one computer 30, 31 and/or a control device 8 may each be connected to one another via a bus system 21 for bidirectional communication, wherein the bidirectional communication may be provided based on a communication protocol for a field bus system, in particular based on a ProfiNet, Ethernet/IP or 802.3 standard, and/or the bidirectional communication may be provided in a wired manner via a bus system 21 or wirelessly by means of Bluetooth or WLAN, based on a standard according to IEEE 802.11 or based on a mobile telecommunication standard. To enable an operation of the component 4, the component 4 may also be connected to a power supply 13.

Further shown is a computer program 20 comprising instructions which, when the program is executed by a computer 30, cause the computer 30 to perform the steps of the method 100 according to embodiments of the invention.

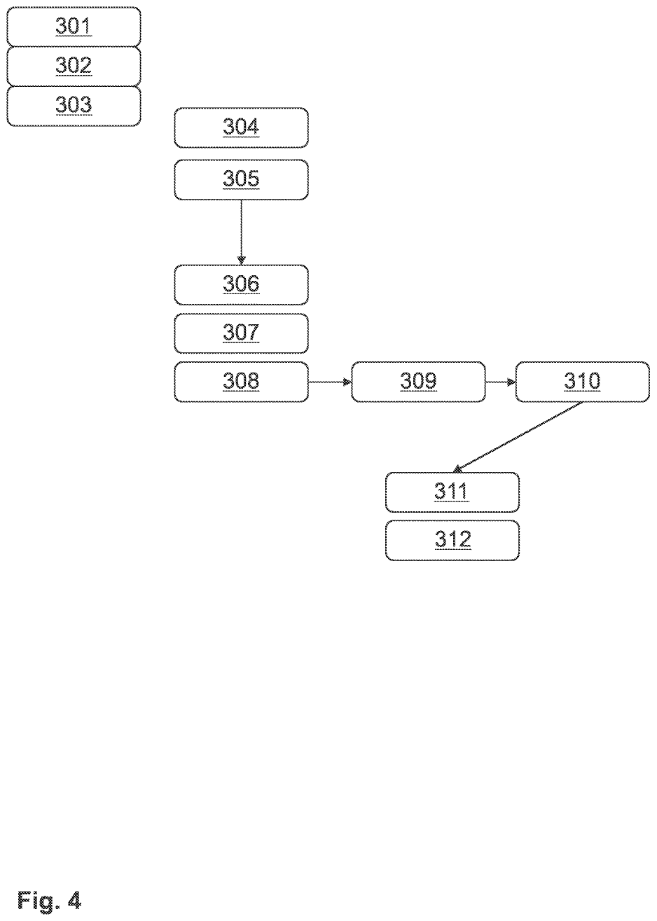

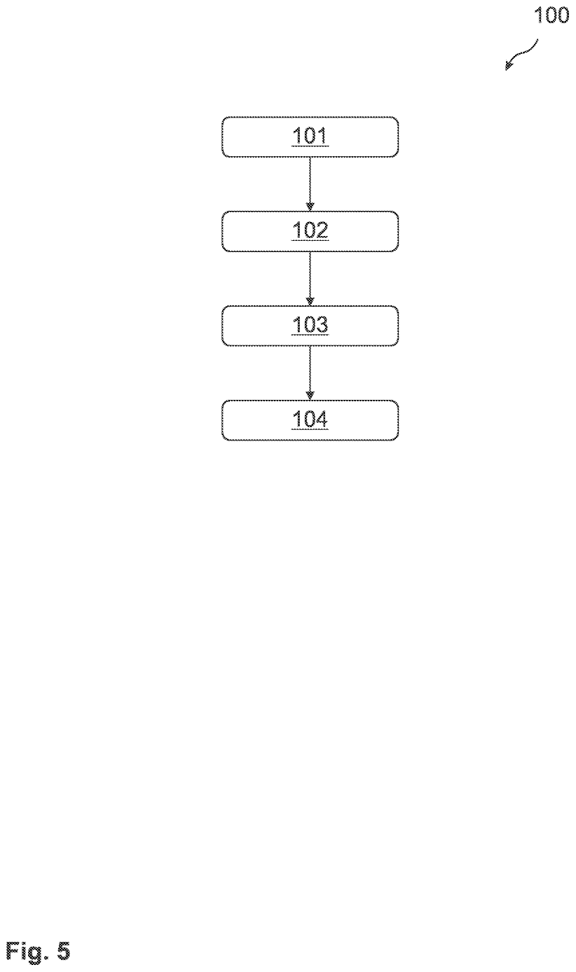

FIGS. 4 and 5 visualize method steps of the method 100. Thus, according to a first method step 101, the identifier 11 of the installation element 10 may be received. Subsequently, according to a second method step 102, an installation specification 200 may be provided 102, which specifies an assignment of the installation element 10 for connection to an electrical component 4, preferably in the form of a connection module 4 for connection to the installation element 10 and further installation elements 10. Then, according to a third method step 103, the electrical component 4 may be identified using the installation specification 200 provided. Then, according to a fourth method step 104, it is possible to initiate the output of at least one installation information based on the received identifier 11 and the identified component 4. The at least one installation information may comprise an installation instruction to support a user during the installation.

The method 100 may provide at least one of the following support options:
Support for the user during installation, especially cabling,
Support for the user in documenting the installation,
Support for the user during testing/automated testing,
Support for the user during disassembly,
Support for engineering during planning,
Support for the PLC programmer.

Initiating the output may comprise initiating an activation of a display element 41 shown in FIG. 3 on the electrical component 4 in order to indicate a connection point 42, in particular a slot 42, for the installation element 10 to be connected by the display element 41. Alternatively or additionally, initiating the output may comprise initiating a display of a connection point 42, in particular a slot 42, of the electrical component 4 for the installation element 10 on a user interface 32 of a computer 31. The user interface 32 may thereby visualize a digital twin of at least a part of the machine 1, and preferably a mechanical and/or an electrical structure of the part of the machine 1. Further alternatives or additional output possibilities include an indication of a connection point 42, in particular a slot 42, of the electrical component 4 for the installation element 10 by means of augmented reality and/or an output of the installation instruction as an instruction for the user to connect the installation element 10 to a specific connection point 42 of the electrical component 4, preferably the connection point 42 being determined based on the installation specification 200. In addition, an acoustic output of the installation instruction may also be provided so that a user may follow the installation instruction without looking at the computer 31. Here, for example, an identifier of the component 4 and/or the corresponding connection point 42 is output verbally.

It is also possible that the installation information comprises an installation configuration and/or installation documentation, which is stored in a data memory 33 and/or transmitted to the electrical component 4.

In order to avoid errors in the documentation that may occur when entering information manually, an automated storage in the system may be advantageous. For example, all information is stored in the correct place in the various documents of the installation specification, such as the circuit diagram or the connection diagram. The person carrying out the respective step then only has to confirm the entries, for example.

The relevant information that may be included in the installation documentation includes, for example
Which component was used (unique, preferably unambiguous labeling)?
On which machine and at which point on the machine was the specific component fitted?
Who connected it and when?
To which port or connection point was the cable connected?
How was the cable connected?
Has the component been connected properly?
Were there any deviations from the plan?

The installation documentation may be used, for example, to document at least one of the following pieces of information: work steps of the user with additional information on the work steps such as a processing duration, which machine is being worked on, which user, for example which installer or fitter, carried out the activities and when, which component has been wired and/or cabled, has the assembly step been completed, which port/connection point was used, are there open cables and what are the properties of the open cable, for example, length, environmental parameters, e.g. temperature, humidity, current project status, protection class, e.g. IP67, the user, in particular the worker, may also enter the reason for the deviation from the plan in the event of deviations from the plan. The installation documentation may be stored in a database, for example. If necessary, a user may trigger the documentation with physical actions (keystroke, screen, double-click).

Furthermore, an evaluation unit may be provided which evaluates the documented information, preferably the processing times of the user for the respective work steps. An artificial intelligence method may also be used for this purpose, which optimizes the results of the evaluation unit, for example. The results show the user potential for optimization in order to make a machine more efficient in the future, to optimize components or assemblies and to improve assembly and disassembly processes. The comments are also taken into account in the event of deviations from the plan.

It is also possible for the documentation to work with components that are not preconfigured or connected to a PLC. This avoids errors that may arise from the use of externally identical but differently configured modules. Thanks to the communication capability of these components and the integration of all relevant information, the system may also be used to guide the user through the installation of the automation technology. The systematic collection and documentation of all relevant information, such as the components used, the execution of installation and maintenance tasks or problems that have occurred, also leads to reliable knowledge about the current system status. By automatically collecting and assigning this information, the process is significantly accelerated and human installers are relieved of the documentation task. The automated collection and storage of information to be documented may significantly reduce the risk of missing and/or incorrect documentation.

In FIG. 4, a method 100 according to embodiments of the invention is visualized with further details. Using a computer 31 shown in FIG. 3, such as a tablet or laptop, a user may first perform a user login 301. For this purpose, the user may use a graphical user interface 32, which is provided by the computer 31. The user interface 32 may also be used to select a project 302, by which, for example, an installation specification 200 for a desired project is loaded. This makes it possible to initiate a start 303 for instructing the user to install the machine 1 by means of at least one installation instruction.

Optionally, after the start 303, a representation 304 of the last executed step, for example the last installation instruction and/or another instruction for the installation, may be provided first. Initially, an identification 305 of an installation element 10 may be performed by the user, wherein the user uses, for example, a detection device 22 such as a handheld scanner to scan an identification means 12 on the installation element 10. Based on the scanned identification means 12, the identifier 11 may then be determined and transmitted to the computer 31 and/or a device 30 for data processing. Using the received identifier 11 and the installation specification 200, the electrical component 4 and its connection point 42 to which the installation element 10 is to be connected may then be identified. For this purpose, the installation specification 200 includes, for example, a matrix in which various installation elements 10 are assigned to the components 4. The user may then be informed by the installation instruction which of the components 4 has been identified. For example, a display element 41 on the component 4 lights up. This may be made possible by a signal transmission 306 from the data processing apparatus 30 to component 4. The user may then establish a connection 307 between the installation element 10 and the component. Based on the installation specification 200, a confirmation 308 of correct installation may be provided. Subsequently, an at least partially automated documentation 309 of the correct assembly and documentation 310 of the completion of the work step in the installation specification 200 may be possible. This may be done, for example, by indicating 311 in a machine overview with a green tick or, for example, by showing the affected connection in an electrical circuit diagram and indicating it to the user via the user interface 32. An identification of an installation element 312 may then be carried out again. By guiding the user, in particular the worker, during the installation of the electrical automation technology and by automatically checking whether a suitable component has been properly connected, error-free production of the system may be ensured.

The user may then establish a connection between the installation element and a device, such as an actuator and/or a hub and/or a sensor (not shown). The installation specification 200 may be used to confirm the correct installation. Subsequently, an at least partially automated documentation of the correct assembly and documentation of the completion of the work step in the installation specification 200 may be possible. This may be done, for example, by indicating a green tick in a machine overview or, for example, by indicating the relevant connection in an electrical circuit diagram and showing it to the user via the user interface 32. These work steps correspond in principle to work steps 307 to 311.

The system 2 according to embodiments of the invention may further comprise at least one information interface for providing the method steps of a method 100. The at least one information interface may comprise at least one of the following information interfaces for transmitting information:
Between the system 2 and the user, in particular a worker and/or a planner and/or a programmer, e.g. for transmitting work instructions and/or project statuses and/or for optimizing planning,
Between the user and the system 2, e.g. for transmitting acknowledgements of the executed work steps and/or comments on the executed work steps,
Between the system 2 and the components 4,
Between the system 2 via a component 4 to one or more devices 5 such as actuators and/or sensors,
Between the system 2 via a component 4 to a hub 6.

The information may be transmitted as a bidirectional information transfer between the system 2 and the components 4. This may be carried out without the individual components 4 being connected to a control system of the machine 1 (PLC 8) and/or preconfigured for their future tasks in the machine 1.

Although some aspects have been described in connection with a device, it is clear that these aspects also constitute a description of the corresponding method, wherein an element or device corresponds to a method step or a feature of a method step. Similarly, aspects described in connection with a method step also constitute a description of a corresponding block or element or feature of a corresponding device.

Embodiments of the invention may be implemented on a computing system. The computing system may be a local computing device (e.g., personal computer, laptop computer, tablet computer, or cell phone) having one or more processors and one or more storage devices, or a distributed computing system (e.g., a cloud computing system having one or more processors and one or more storage devices distributed at various locations, such as at a local client and/or one or more remote server farms and/or data centers). The computer system may comprise any circuitry or combination of circuitry. In one embodiment, the computer system may comprise one or more processors of any type. As used herein, the term “processor” may refer to any type of computing circuit, such as a microprocessor, a microcontroller, a complex instruction set computing (CISC) microprocessor, a reduced instruction set computing (RISC) microprocessor, a very long instruction word (VLIW) microprocessor, a graphics processor, a digital signal processor (DSP), a multicore processor, a field programmable gate array (FPGA), or any other type of processor or processing circuit. Other types of circuitry that may be included in the computer system may be a customer specific circuit, an application specific integrated circuit (ASIC), or the like, such as one or more circuits (e.g., a communication circuit) for use in wireless devices such as cellular telephones, tablet computers, laptop computers, two-way radios, and similar electronic systems. The computer system may include one or more storage devices, which may include one or more storage elements suitable for the particular application, such as main memory in the form of random access memory (RAM), one or more hard disks, and/or one or more drives that handle removable media such as compact disks (CD), flash memory cards, digital video disks (DVD), and the like. The computer system may also include a display device, one or more speakers, and a keyboard and/or control device, which may include a mouse, trackball, touch screen, voice recognition device, or other device that allows a system user to input information to and receive information from the computer system.

Some or all of the method steps may be performed by (or using) a hardware device, such as a processor, a microprocessor, a programmable computer, or an electronic circuit. In some embodiments, some or more of the main method steps may be performed by such a device. Depending on specific implementation requirements, embodiments of the invention may be implemented in hardware or in software. The implementation may be carried out using a non-transferable storage medium such as a digital storage medium, for example a floppy disk, a DVD, a Blu-Ray, a CD, a ROM, a PROM, an EPROM, an EEPROM or a FLASH memory, on which electronically readable control signals are stored, which interact (or may interact) with a programmable computer system so that the respective method is carried out. Therefore, the digital storage medium may be computer readable.

Some embodiments of the invention comprise a data carrier having electronically readable control signals capable of cooperating with a programmable computer system so that one of the methods described herein is performed.

In general, embodiments of the present invention may be implemented as a computer program product comprising a program code, wherein the program code is for performing one of the methods when the computer program product is running on a computer. For example, the program code may be stored on a machine-readable medium.

Other embodiments comprise the computer program for performing one of the methods described herein stored on a machine-readable medium.

In other words, therefore, one embodiment of the present invention is a computer program comprising a program code for performing any of the methods described herein when the computer program is running on a computer.

Thus, another embodiment of the present invention is a storage medium (or data carrier or computer readable medium) on which the computer program for performing any of the methods described herein is stored when executed by a processor. The data carrier, digital storage medium or recorded medium is typically tangible and/or non-transferable. Another embodiment of the present invention is an apparatus as described herein comprising a processor and the storage medium.

Thus, a further embodiment of the invention is a data stream or sequence of signals representing the computer program for performing one of the methods described herein. For example, the data stream or sequence of signals may be configured to be transmitted via a data communication link, for example via the Internet.

Another embodiment comprises a processing means, such as a computer or programmable logic device, configured or adapted to perform any of the methods described herein.

Another embodiment comprises a computer on which the computer program for performing one of the methods described herein is installed.

Another embodiment of the invention includes an apparatus or system configured to transmit (e.g., electronically or optically) a computer program to a receiver for performing any of the methods described herein. The receiver may be, for example, a computer, a mobile device, a storage device, or the like. The device or system may include, for example, a file server for transmitting the computer program to the receiver.

In some embodiments, a programmable logic device (e.g., a field programmable gate array) may be used to perform some or all of the functions of the methods described herein. In some embodiments, a field programmable gate array may cooperate with a microprocessor to perform any of the methods described herein. In general, the methods are preferably performed by any hardware device.

### LIST OF REFERENCE SIGNS

1 Machine, plant
2 System
3 Master module
4 Module, switch, component, connection module
5 Devices, sensor, actuator
6 Hub
8 Control device, PLC
9 Control cabinet
10 Installation element
11 Identifier
12 Identification means, machine-readable code
13 Energy supply
20 Computer program
21 Bus system
22 Detection device
30 Device
31 Computer
32 User interface
33 Data memory
41 Display element
42 Connection point, slot
100 Method
101 First method step
102 Second method step
103 Third method step
104 Fourth method step
200 Installation specification
301 User login
302 Project selection
303 Start guide
304 Illustration of last executed step
305 Identification of an installation element, in particular a cable
306 Signal to component to light up the display element
307 Connection between cable and module established
308 Confirmation of correct assembly
309 Documentation correct assembly
310 Documentation Work step completed
311 Presentation of machine overview
312 Identification of an installation element

1. A method for a computer-aided installation of spatially decentralized, electrical components of a machine, in particular a plant, comprising:
receiving an identifier of an installation element providing an installation specification which specifies an assignment of the installation element for connection to an electrical component the form and
identifying the electrical component based on the provided installation specification; and
initiating an output of at least one installation information based on the received identifier and the identified component.

2. The method according to claim 1, wherein the at least one installation information comprises an installation instruction for assisting a user in the installation, wherein initiating the output comprises at least one of the following steps:
initiating an activation of a display element on the electrical component in order to indicate a connection point, in particular a slot, for the installation element to be connected by means of the display element;
initiating an indication of a connection point, in particular a slot, of the electrical component for the installation element on a user interface of a computer, wherein the user interface visualizes a digital twin of at least a part of the machine
initiating an indication of a connection point, in particular a slot, of the electrical component for the installation element by means of augmented reality;
initiating an output of the installation instruction as an instruction for the user to connect the installation element to a specific connection point of the electrical component
initiating an acoustic output, in particular a voice output, of the installation instruction.

3. The method according to claim 1, wherein the method comprises the following further step:
detecting a connection state between the installation element and the electrical component to determine whether the connection has been established, detecting the connection state comprising:
receiving an installation message based on an input from the user and/or from the electrical component,
wherein the received installation message indicates that the connection of the installation element to the electrical component has been established.

4. The method according to claim 3, wherein the method comprises the following further steps:
verifying the connection, preferably using the installation specification, in particular in order to determine whether a user has correctly implemented the installation information in the form of an installation instruction, wherein the subsequent step is carried out in the event of a positive verification:
storing the labeling of the connection point as a correctly connected connection point in the installation specification;
wherein at least one of the following steps is advantageously carried out in the event of a negative verification:
storing a labeling of the connection point as a changed connected connection point in the installation specification.

5. The method according to claim 1, wherein the at least one installation information comprises an installation instruction for assisting a user in a reconstruction of the machine.

6. The method according to claim 1, wherein initiating the output comprises initiating a bidirectional communication with the identified component via a bus system.

7. The method according to claim 1, wherein at least one of the following specifications is received, to create a digital twin of the installation element and/or the electrical component based on the received identifier and the identified component: Component type, machine type, plant type, user, connection point designation, time stamp date and time, installation duration, address in a bus system, equipment identification, cable length, port assignment, properties of the open cable, temperature, humidity, current project status during installation, deviation from plan and/or reason.

8. The method according to claim 1, wherein the installation information comprises an installation configuration and/or an installation documentation, which is stored in a data memory and/or transmitted to the electrical component.

9. The method according to claim 1, wherein the installation information comprises a unique labeling which characterizes the installation element and/or the identified component, wherein the installation information is stored in the installation specification, in particular in a digitized construction plan, wherein the installation element is selected from a plurality of similar installation elements and/or the identified component is selected from a plurality of similar components based on the identifier.

10. The method according to claim 1, wherein the installation specification comprises a predefined specification about a modular and/or decentralized structure of the machine, in particular of the plant in particular via an interconnection of the installation elements in the form of cables and/or components by means of the component in the form of connection modules.

11. The method according to claim 1, wherein a configuration of the component is carried out using the identifier in order to transfer the component from a base-configured state.

12. A system for a computer-aided installation of spatially decentralized, electrical components of a machine, comprising:
a detection device, in particular a scanner or a camera, for providing an identifier of an installation element, a
at least one electrical component;
a data processing apparatus comprising computing instructions, that when executed by the data processing apparatus, cause the data processing apparatus to:
receive an identifier of an installation element; and
initiate an output of at least one installation information based on the received identifier and an identified electrical component.

13. The system according to claim 12, wherein the identifier is encoded in a machine-readable code associated with the installation element, in particular arranged thereon, wherein the machine-readable code is machine-readable by means of the detection device; and/or
wherein the components and a computer and/or a control device are each connected to one another via a bus system for bidirectional communication, wherein the bidirectional communication is provided based on a communication protocol for a field bus system, in particular based on a ProfiNet, Ethernet/IP or 802.3 standard, and/or the bidirectional communication is provided in a wired manner via a bus system or wirelessly by means of Bluetooth or WLAN, based on a standard in accordance with IEEE 802.11 or based on a mobile radio telecommunications standard.

14. (canceled)

15. (canceled)

16. The system of claim 12, wherein the computing instructions, when executed by the data processing apparatus, further cause the data processing apparatus to:
provide an installation specification, which specifies an assignment of the installation element for connection to an electrical component for connection to the installation element and further installation elements; and
provide an identification of the electrical component based on the provided installation specification.

17. A non-transitory computer-readable medium storing computing instructions for data processing, the computing instructions, when executed by one or more processors, cause the one or more processors to:
receive an identifier of an installation element; and
initiate an output of at least one installation information based on the received identifier and an identified electrical component.

18. The non-transitory computer-readable medium of claim 17, wherein the computing instructions, when executed by the one or more processors, further cause the one or more processors to:
provide an installation specification, which specifies an assignment of the installation element for connection to an electrical component for connection to the installation element and further installation elements; and
provide an identification of the electrical component based on the provided installation specification.
